(19) United States
(12) Patent Application Publication
(10) Pub. No.: US 2010/0025875 A1
(43) Pub. Date: Feb. 4, 2010

(54) MOLD CLOSING SYSTEM AND METHOD FOR INJECTION MOLDING MACHINE

(75) Inventor: HAN-CHIEH CHANG, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: FOXNUM TECHNOLOGY CO., LTD., Tucheng City (TW)

(21) Appl. No.: 12/237,238

(22) Filed: Sep. 24, 2008

(30) Foreign Application Priority Data
Jul. 31, 2008 (CN) 200810303297.3

(51) Int. Cl. B29C 47/92

(52) U.S. Cl. 264/40.5; 425/150

(57) ABSTRACT

A mold closing system for an injection molding machine includes a voltage source, a controller, a driving unit, a first mold portion, a second mold portion, a fixed platen, and a movable platen. The first mold portion is secured on the movable platen. The second mold portion is secured on the fixed platen. The first and second mold portions may be insulated from their respective platens. The control device controls voltage from the voltage source to charge the first and second mold portions, and detects the voltage between the first and second mold portions. Until the voltage between the first and second mold portions equals zero, the control device moves the movable platen toward the fixed platen. A mold closing method is also described.

### BACKGROUND

1. Field of the Invention

The present disclosure relates to a mold closing system and a mold closing method for injection molding machines.

2. Description of the Related Art

When an injection molding machine is closing mold portions, a controller moves a movable platen toward a fixed platen until mold portions fixed on the movable and fixed platens contact each other. When the mold is closed, a clamping force is generated between the mold portions fixed on the movable and fixed platens. Typical injection molding machines determine if the mold is closed by detecting the distance between the mold portions fixed on the movable and fixed platens. However, detectors do not always accurately detect mold closing.

Therefore, there is room for improvement within the art.

### BRIEF DESCRIPTION OF THE DRAWINGS

FIG. 1 is a block diagram of an exemplary embodiment of a mold closing system for an injection molding machine.

FIG. 2 is a schematic diagram of the injection molding machine in a mold-open state.

FIG. 3 is similar to FIG. 2, but showing the injection molding machine in a mold clamping state.

FIG. 4 is a flowchart of one embodiment of an exemplary mold closing method.

### DETAILED DESCRIPTION

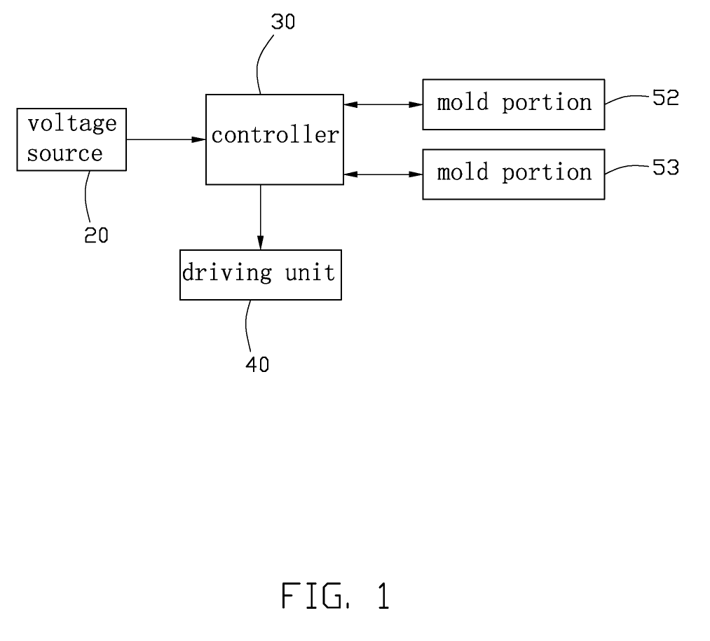

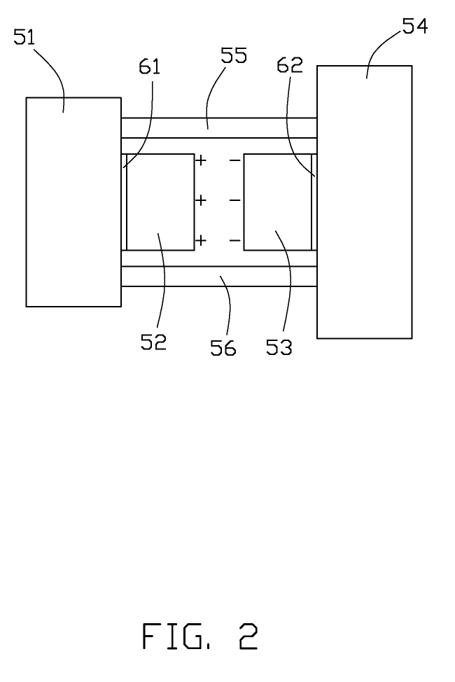

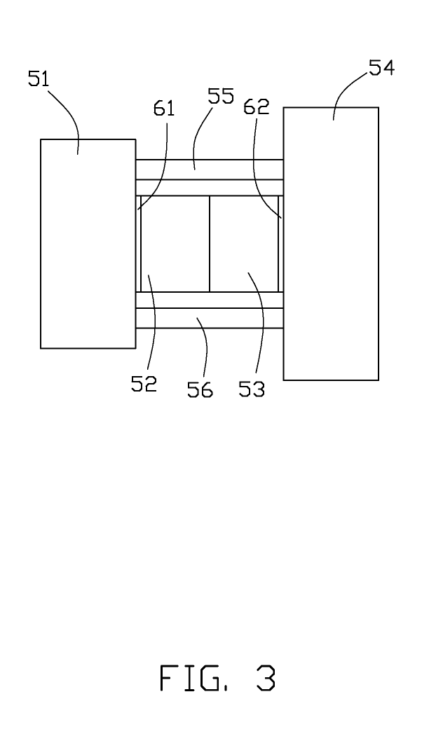

Referring to FIGS. 1-3, an exemplary mold closing system for an injection molding machine includes a voltage source 20, a controller 30, a driving unit 40, two mold portions 52, 53, a movable platen 51, a fixed platen 54, and two tie bars 55, 56. One mold portion 52 is secured on the movable platen 51. The other mold portion 53 is secured on the fixed platen 54. Bakelite plates 61 and 62 may be applied for insulating the mold portion 52 from the movable platen 51, and the mold portion 53 from the fixed platen 54. Other types of insulation plates, such as marble and ceramic plates, can also be used. The controller 30 is electrically connected to the voltage source 20, the mold portion 52, and the mold portion 53. The controller 30 controls voltage from the voltage source 20 to, for example, positively charge the mold portion 52 and negatively charge the mold portion 53. The controller 30 is further configured for detecting a voltage between the mold portions 52 and 53 and controlling the driving unit 40 to control the movement of the movable platen 51 according to the detected voltage between the mold portions 52 and 53. If the detected voltage between the mold portions 52 and 53 is greater than zero, the mold is not closed. The controller 30 controls the driving unit 40 to drive the movable platen 51 toward the fixed platen 54 along the tie bars 55 and 56. If the detected voltage between the mold portions 52 and 53 equals zero, the mold portions 52 and 53 are contacting each other and the mold is closed. The controller 30 controls the driving unit 40 to stop driving the movable platen 51 toward the fixed platen 54.

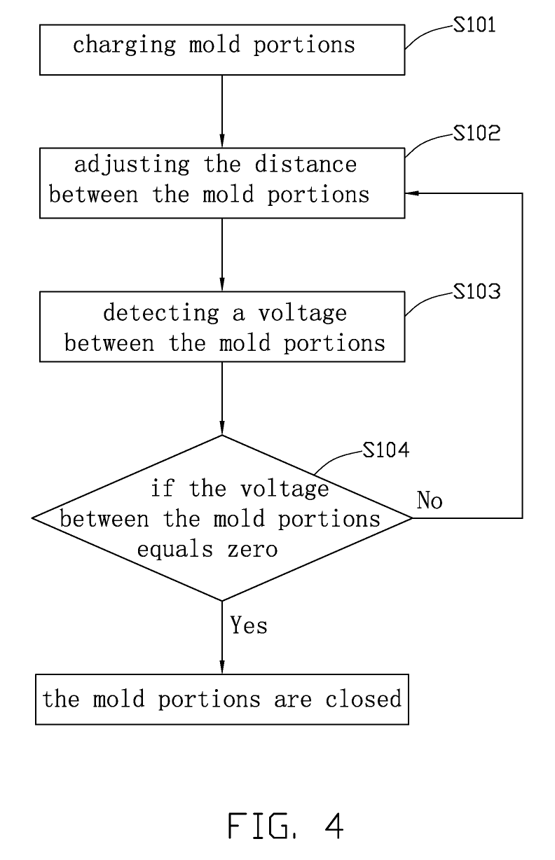

Referring to FIG. 4, a mold closing method may include the following blocks.

In block S101, the controller 30 controls voltage from the voltage source 20 to positively charge the mold portion 52 and negatively charge the mold portion 53.

In block S102, the controller 30 controls the driving unit 40 to drive the movable platen 51 toward the fixed platen 54 along the tie bars 55 and 56 for adjusting the distance between the movable platen 51 and the fixed platen 54.

In block S103, The controller 30 detects a voltage between the mold portions 52 and 53.

In block S104, the controller 30 determines whether the voltage between the mold portions 52 and 53 equals zero. If the voltage between the mold portions 52 and 53 equals zero, the mold is closed; if the voltage between the mold portions 52 and 53 does not equal zero, the system returns to the block S102 until the mold is detected as being closed.

The foregoing description of the exemplary embodiments of the disclosure has been presented only for the purposes of illustration and description and is not intended to be exhaustive or to limit the disclosure to the precise forms disclosed. Many modifications and variations are possible in light of the above everything. The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope. Accordingly, the scope of the present disclosure is defined by the appended claims rather than the foregoing description and the exemplary embodiments described therein.

1-4. (canceled)

5. A mold closing method, comprising:
controlling voltage from a voltage source to positively charge a first mold portion and negatively charge a second mold portion;
controlling a driving unit to drive a movable platen toward a fixed platen;
detecting a voltage between the first and second mold portions;
determining whether the voltage between the first and second mold portions equals zero, wherein the voltage between the first and second mold portions equals zero upon the condition that the first and second mold portions are closed;
controlling the driving unit to stop driving the movable platen toward the fixed platen upon the condition that the voltage between the first and second mold portions equals zero; and
controlling the driving unit to continue driving the movable platen toward the fixed platen upon the condition that the voltage between the first and second mold portions does not equal zero.

6. The mold closing method as claimed in claim 5, further comprising insulating the movable platen from the first mold portion by a first bakelite plate and insulating the fixed platen from the second mold portion by a second bakelite plate.

7. The mold closing method as claimed in claim 5, further comprising insulating the movable platen from the first mold portion by a first marble plate and insulating the fixed platen from the second mold portion by a second marble plate.

8. The mold closing method as claimed in claim 5, further comprising insulating the movable platen from the first mold portion by a first ceramic plate and insulating the fixed platen from the second mold portion by a second ceramic plate.
